(19) United States
(12) Patent Application Publication
(10) Pub. No.: US 2014/0065320 A1
(43) Pub. Date: Mar. 6, 2014

(54) HYBRID COATING SYSTEMS AND METHODS

(71) Applicants: Dechao Lin, (US); Ganjiang Feng, (US); Skikanth Chandrudu Kottilingam, (US); Yan Cui, (US); Brian Lee Tollison, (US)

(72) Inventors: Dechao Lin, (US); Ganjiang Feng, (US); Skikanth Chandrudu Kottilingam, (US); Yan Cui, (US); Brian Lee Tollison, (US)

(21) Appl. No.: 13/599,079

(22) Filed: Aug. 30, 2012

(51) Int. Cl. B05D 1/00; B05C 9/12; B05D 3/06

(52) U.S. Cl. 427/554; 118/620; 427/580

(57) ABSTRACT

Hybrid coating systems include an electrospark deposition device having an electrode that deposits a coating on a substrate and a laser that produces a laser beam directed towards at least a portion of the coating as the coating is deposited on the substrate.

### BACKGROUND OF THE INVENTION

The subject matter disclosed herein relates to coating systems and methods and, more specifically, to hybrid coating systems and methods.

Metal and alloy components in a variety of industrial applications often require a variety of coating or welding operations during manufacturing and/or repair. For example, gas turbine engines include fuel nozzles to deliver combustion fuel to combustor components. Over a period of extended use, fuel nozzles may experience deterioration, e.g., around the edges of the nozzle tip. Processes that build metal layers by traditional fusion welding pose risks that the brazed joints may be damaged by the heat applied by the welding process. Also, distortion induced by the welding processes may not be acceptable for the tolerances required of turbine components such as a primary fuel nozzle. In order to avoid the risks associated with fusion welding, a process with a low heat input may be used. Laser cladding may be sufficiently low temperature for restoring a nozzle tip to the correct dimensions, but depositing metal on the edge of a nozzle using laser cladding techniques can be difficult.

Alternatively, an electrospark deposition (ESD) process can have a very low heat input. Electrospark deposition transfers stored energy to a consumable electrode, e.g., carbides (W, Ti, Cr etc.) stainless steel, aluminum, and other electrode compositions. The electrode material can be ionized and transferred to the substrate surface, producing an alloy with the substrate and a deposition on the alloyed electrode-substrate interface. The deposited layer can thereby metallurgically bond on the alloyed substrate and electrode material. While electrospark deposition may provide a deposition process with a relatively low heat input and a small heat affected zone (HAZ), the deposition process can be relatively slow making it potentially time consuming to coat a large area. Moreover, the resulting coating can be relatively rough due to the specific application process and potentially require additional finishing steps.

Accordingly, alternative hybrid coating systems and methods would be welcome in the art.

### BRIEF DESCRIPTION OF THE INVENTION

In one embodiment, a hybrid coating system is disclosed. The hybrid coating system includes an electrospark deposition device having an electrode that deposits a coating on a substrate. The hybrid coating system further includes a laser that produces a laser beam directed towards at least a portion of the coating as the coating is deposited on the substrate.

In another embodiment, a hybrid coating method for depositing a coating is disclosed. The hybrid coating method includes providing a substrate having a surface, depositing the coating from an electrode of an electrospark deposition device onto the surface of the substrate along a deposition direction, and directing a laser beam onto at least a portion of the coating as the coating is deposited in the deposition direction.

In yet another embodiment, another hybrid coating method for depositing a coating is disclosed. The hybrid coating method includes providing a substrate having a surface, directing a laser beam onto at least a portion of a tip of an electrode of an electrospark deposition device, and depositing the coating from the electrode of the electrospark deposition device onto the surface of the substrate while the laser is directed onto at least the portion of the tip of the electrode.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a schematic illustration of a side view of a hybrid coating system according to one or more embodiments shown or described herein;

FIG. 2 is an overhead view of a coating being deposited via the hybrid coating system of FIG. 1 according to one or more embodiments shown or described herein; and,

FIG. 3 is an illustration of a hybrid coating method according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Hybrid coating systems generally comprise electrospark deposition devices and lasers. The electrospark deposition device is capable of depositing a relatively thin coating onto a surface of a substrate. The laser directs a laser beam onto at least a portion of the deposited coating and/or the tip of the electrode while the electrospark deposition device deposits the coating. By directing the energy of the laser beam to the deposited coating and/or the tip of the electrode of the electrospark deposition device, the electrospark deposition device can apply a smoother coating at a faster rate. Hybrid coating systems and hybrid coating methods will now be described in more detail herein.

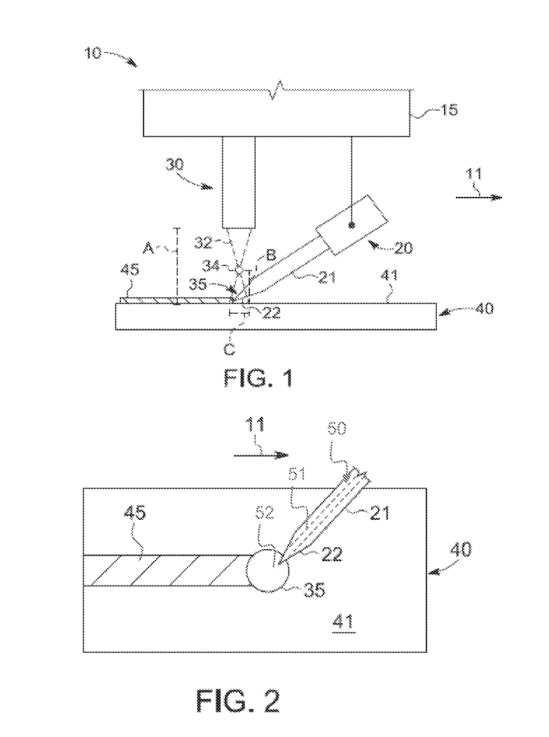

Referring now to FIGS. 1 and 2, a hybrid coating system 10 is illustrated. The hybrid coating system 10 generally comprises an electrospark deposition device 20 and a laser 30. The electrospark deposition device 20 can comprise any device capable of electrospark deposition (ESD). For example, in some embodiments, such as that illustrated in FIGS. 1 and 2, the electrospark deposition device 20 comprises an electrode 21 comprising a tip 22. In some embodiments, the electrode 21 can comprise a consumable electrode 21 that may rotate during deposition. The electrode 21 can comprise any material suitable for forming a metallurgical bond with the substrate 40. Non-limiting examples of potential electrode 21 materials include copper, brass, stainless steel, nickel based alloys, tungsten, graphite, and combinations thereof. In such embodiments, the electrode 21 can be placed into contact with a surface 41 of a substrate 40. The substrate 40 can, for example, comprise any metal or alloy substrate such as component of a gas turbine (e.g., nozzles, blades, vanes, buckets, combustors, etc.). In some embodiments, the material of the electrode 21 may be the same as the material of the substrate 40.

In operation, the electrospark deposition device 20 can deposit a coating 45 onto the surface 41 of the substrate 40. For example, if the electrospark deposition device 20 comprises a consumable electrode, the electrode 21 can be rotated and brought into contact with the surface 41 of the substrate 40. Contemporaneously, the electrode 21 and the substrate 40 can be oppositely charged such that material is deposited from the electrode 21 onto the surface in a plurality of sparks to form the coating 45. The process can continue in the deposition direction 11 by moving the electrospark deposition device 20 relative to a stationary substrate 40, by moving the substrate 40 relative to a stationary electrospark deposition device 20, or combinations thereof. The process can continue to deposit the coating 45 to cover any suitable area of the substrate 40. Moreover, the coating 45 may comprise any thickness achievable from the electrospark deposition device 20. For example, in some embodiments the coating 45 may have a thickness up to about 100 μm.

In some embodiments, a shielding gas may be provided around the tip 22 of the electrode 21. The shielding gas can comprise, for example, argon, nitrogen, helium, or the like or combinations thereof. In some specific embodiments, the shielding gas may be preheated prior to being provided around the tip 22 of the electrode 21 to help increase the potential deposition rate from the electrospark deposition device 20.

In even some embodiments, the electrospark deposition device 20 may comprise a powder feeding device (not illustrated) comprising at least one powder feeding channel for introducing a powder material into a discharging gap between the electrode 21 and the substrate 41. In such embodiments, the powder feeding channel of the powder feeding device may be configured within or outside the electrode 21. For example, the powder feeding device may comprise a powder feeding channel configured within the electrode 21. The powder feed channel within the electrode 21 may comprise any structurally suitable type of channel with several examples including, but not limited to, holes, slots, and annular grooves. Alternatively or additionally, the powder feeding device may comprise a powder feeding channel provided outside the electrode. In certain embodiments, the powder feeding device comprises a powder feeding channel at least partially surrounding the electrode, which may comprise an annular groove surrounding the electrode, or a plurality of channels that substantially surrounds the electrode. The powder material in such embodiments can include, for example, stainless steel, nickel based alloys, and nickel coated Al₂O₃, and combinations thereof. In even some embodiments, graded and composite coatings may be deposited, for example, by choosing different electrodes and/or powder materials.

It should be appreciated that the construction and arrangement of the electrospark deposition device 20 illustrated in FIG. 1 is illustrative only. Although only a few embodiments have been described in detail in this disclosure, those skilled in the art should appreciate that many modifications are possible including variations in sizes, dimensions, structures, shapes and proportions of the various elements, values of parameters, mounting arrangements, use of materials, colors, orientations, speeds, etc.

Still referring to FIGS. 1 and 2, the hybrid coating system further comprises the laser 30. The laser 30 can comprise any laser system that can produce and direct a laser beam 32 towards a target area. For example, in some embodiments, the laser 30 can be selected from a Nd: YAG laser, a CO₂ laser, a fiber laser, and a disk laser. In some embodiments, the laser 30 can produce a laser beam 32 of less than or equal to about 500 watts. Specifically, the laser 30 can produce a laser beam 32 that can be directed towards at least a portion of the coating 45 and/or at least a portion of the tip 22 of the electrode 21 while the coating 45 is deposited by the electrospark deposition device 20. In some embodiments, the laser 30 can produce a laser beam 32 that is also directed towards at least a portion of the tip 22 of the electrode 21. Furthermore, the laser 30 can produce either a pulsed or a continuous laser beam 32.

In some embodiments, such as that illustrated in FIGS. 1 and 2, the laser 30 can produce a defocused laser beam 32. For example, the defocused laser 30 can comprise a defocused laser beam 32 that is positively defocused. As used herein “positively defocused” means that the focus point 34 of the defocused laser 30 is above the surface 41 of the substrate 40, such that the remaining energy of the defocused laser beam 32 from the laser 30 is directed outward towards the surface 41 of the substrate 40 in a wider manner. The defocused laser beam 32, unlike a focused laser beam, can provide energy that is more evenly dispersed over a laser spot width C of the laser spot 35, instead of at a single point on the surface 41 of the substrate 40. The resulting laser spot 35 can thereby cover at least a portion of the coating 45 and/or the tip 22 of the electrode 21 while the coating 45 is being deposited.

The laser 30 can be disposed at a laser height A away from the surface 41 of the substrate 40. Laser height A can be defined by the manufacture of the laser head. In one embodiment, laser height A between the laser head and the surface 41 of the substrate 40 remains fixed. In an alternative embodiment, laser height A varies. Likewise, the focus height “B” comprises the distance from the focus point 34 to the surface 41 of the substrate 40. The focus height B may be varied depending on the size of the coating 45 being deposited and/or the size of the tip 22 of the electrode 21. In one embodiment, the focus height B is approximately 5 millimeters to approximately 15 millimeters, or alternatively approximately 8 millimeters to approximately 13 millimeters, or alternatively approximately 10 millimeters to approximately 12 millimeters. By applying the energy of the laser beam 32 to the coating 45 and/or the tip 22 of the electrode 21, the coating 45 may be deposited at a faster rate and/or have a smoother surface than if the laser beam 32 were not present.

Referring to FIG. 1, in some embodiments, the electrospark deposition device 20 and the laser 30 may be connected to a common mount 15. Such an embodiment may facilitate the laser 30 moving with the electrospark deposition device 20 as it deposits the coating 45 in the deposition direction 11. In other embodiments, the electrospark deposition device 20 and the laser 30 may be connected to separate fixtures but still transverse the substrate 40 in coordinated movement such as via an autofocus on the laser 30 that follows the movement of the tip 22 of the electrode 21. In even yet another embodiment, the electrospark deposition device 20 and the laser may be held stationary, either being connected to the common mount 15 or to separate mounts, while the substrate 40 moves relative to both devices. While specific embodiments and layouts of the electrospark deposition device 20 and the laser 30 have been presented herein, it should be appreciated that these are exemplary only and other types, relative positioning, movement and other parameters may additionally or alternatively be incorporated.

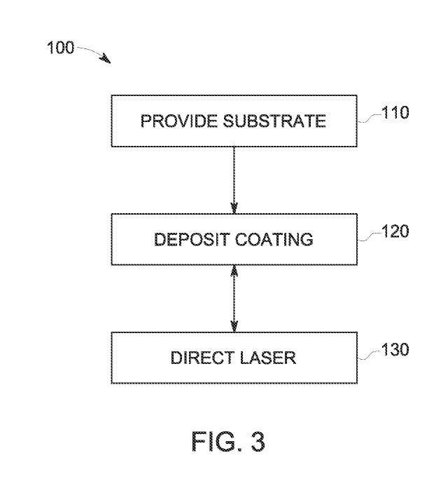

Referring no to FIG. 3, a hybrid coating method 100 is illustrated for depositing a coating onto a substrate using the hybrid coating systems disclosed herein. Specifically, with additional reference to the hybrid coating system 10 illustrated in FIGS. 1 and 2, the hybrid coating method 100 first comprises providing a substrate 40 having a surface 41 in step 110. As discussed above, the substrate can comprise any metal or alloy component capable of bonding with the coating 45 deposited from the electrospark deposition device 20. In some embodiments, the substrate 40 may comprise a component from a gas turbine such as a nozzle, blade, vane, bucket, combustor or the like.

The hybrid coating method 100 further comprises depositing the coating 45 from the electrode 21 of the electrospark deposition device 20 onto the surface 41 of the substrate 40 along the deposition direction 11 in step 120. The hybrid coating method 100 also comprises directing a laser beam 32 onto at least a portion of the coating 45 as the coating 45 is deposited in the deposition direction 11 in step 130. As illustrated in FIG. 3, the deposition in step 120 and the laser production in step 130 may occur in a variety of sequences. For example, in some embodiments both steps 120 and 130 may start and end simultaneously. In other embodiments, the steps 120 and 130 may start and stop at different times but still occur for at least some portion of simultaneous execution. In even some embodiments, steps 120 and 130 may alternate repeatedly such that each step 120,130 occurs for a brief interval before the other step 120,130 resumes.

It should now be appreciated that hybrid coating systems and methods can be utilized to deposit coatings via electrospark deposition at a faster deposition rate and with a smoother surface. Specifically, the additional presence of the laser beam, particularly a defocused laser beam, can provide additional energy to both the coating and the tip of the electrode. This additional energy can preheat the tip to increase the deposition rate while also helping melt the coating on-site to provide a more smooth and dense coating with reduced porosity and increased fusion. Hybrid coating systems and methods can thereby be utilized in a variety of applications such as, for example, repair, micro-welding and coating.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A hybrid coating system comprising:
an electrospark deposition device comprising an electrode that deposits a coating on a substrate; and,
a laser that produces a laser beam directed towards at least a portion of the coating as the coating is deposited on the substrate.

2. The hybrid coating system of claim 1, wherein the laser beam is also directed onto at least a portion of a tip of the electrode.

3. The hybrid coating system of claim 1, wherein the laser beam is a defocused laser beam.

4. The hybrid coating system of claim 3, wherein the defocused laser beam is positively defocused.

5. The hybrid coating system of claim 1, wherein the laser beam is a pulsed laser beam.

6. The hybrid coating system of claim 1, wherein the electrode comprises a consumable electrode.

7. The hybrid coating system of claim 6, wherein the consumable electrode comprises a preheated tip.

8. The hybrid coating system of claim 1, wherein the electrospark deposition device further comprises a powder feeding device comprising at least one powder feeding channel for introducing a powder material into a discharging gap between the electrode and the substrate, and wherein the electrode deposits the powder material to form the coating.

9. The hybrid coating system of claim 1, wherein the electrospark deposition device and the laser are connected to a common mount.

10. The hybrid coating system of claim 1, wherein the electrospark deposition device and the laser advance together in a deposition direction.

11. A hybrid coating method for depositing a coating, the hybrid coating method comprising:
providing a substrate having a surface;
depositing the coating from an electrode of an electrospark deposition device onto the surface of the substrate along a deposition direction; and,
directing a laser beam onto at least a portion of the coating as the coating is deposited in the deposition direction.

12. The hybrid coating method of claim 11 further comprising directing the laser beam onto at least a portion of a tip of the electrode.

13. The hybrid coating method of claim 12 further comprising preheating at least the portion of the tip prior to depositing the coating.

14. The hybrid coating method of claim 11, wherein the laser beam comprises a defocused laser beam.

15. The hybrid coating method of claim 11, wherein the electrode comprises a consumable electrode.

16. The hybrid coating method of claim 11 further comprising providing a shielding gas around a tip of the electrode while depositing the coating.

17. The hybrid coating method of claim 11, wherein the electrospark deposition device comprises a powder feeding device comprising at least one powder feeding channel for introducing a powder material into a discharging gap between the electrode and the substrate, and wherein the electrode deposits the powder material to form the coating.

18. A hybrid coating method for depositing a coating, the hybrid coating method comprising:
providing a substrate having a surface;
directing a laser beam onto at least a portion of a tip of an electrode of an electrospark deposition device; and,
depositing the coating from the electrode of the electrospark deposition device onto the surface of the substrate while the laser is directed onto at least the portion of the tip of the electrode.

19. The hybrid coating method of claim 18, wherein the laser beam comprises a defocused laser beam.

20. The hybrid coating method of claim 18, wherein the electrode comprises a consumable electrode.
